(19) United States
(12) Patent Application Publication
(10) Pub. No.: US 2024/0323605 A1
(43) Pub. Date: Sep. 26, 2024

(54) WIRELESS AUDIO SYSTEM

(71) Applicant: Shure Acquisition Holdings, Inc., Niles, IL (US)

(72) Inventors: John Born, Chicago, IL (US); Michael Chad Wiggins, Gilberts, IL (US); William John Oakley, Long Grove, IL (US); Roger Grinnip, Lake Zurich, IL (US); Michael Lester, Buena Vista, CO (US); Paul Massaro, Niles, IL (US)

(21) Appl. No.: 18/613,981

(22) Filed: Mar. 22, 2024

Related U.S. Application Data
(60) Provisional application No. 63/453,927, filed on Mar. 22, 2023.

(51) Int. Cl. H04R 3/12

(52) U.S. Cl. CPC H04R 3/12; H04R 2420/07

(57) ABSTRACT

Aspects of the disclosure relate to an audio system architecture designed for sound reinforcement. The audio system may comprise one or more input device(s), one or more output device(s), one or more wireless hubs, and one or more user computing devices. Connections between the input device(s), output device(s), and the one or more wireless hubs may be wireless and automated and/or managed via the one or more user computing devices. The user computing devices or the wireless hub may adjust a configuration of each of the devices in the audio system. One or more of the devices in the audio system may be capable of a network connection which may enable recording, live-streaming to remote audiences, system management and operation, cloud-based storage and/or processing, and more.

### CROSS-REFERENCE TO RELATED APPLICATIONS

The present application claims priority to U.S. Provisional Application Ser. No. 63/453,927, titled “WIRELESS AUDIO SYSTEM,” filed Mar. 22, 2023, the entire contents of which are incorporated herein by reference.

### TECHNICAL FIELD

Aspects of the disclosure relate to an audio system and more specifically to configuration and control of components of an audio system.

### BACKGROUND

An audio system may comprise multiple devices (e.g., microphones, receivers, mixers, amplifiers, speakers, personal monitoring devices, etc.). Communication between devices in an audio system often require a plurality of wired connections (e.g., cables, connectors, etc.). Further, control of the multiple devices may require multiple interfaces, cables, and control devices. The use of multiple devices, cables, and associated control interfaces may result in coordination and contention issues, in addition to increased complexity. The inventors have developed solutions to the aforementioned drawbacks and more, as disclosed herein.

### SUMMARY

Aspects of the disclosure provide effective, scalable, and reliable technical solutions that address and overcome the problems associated with operation of complex audio systems comprising multiple devices.

An example audio system may comprise a wireless hub, one or more input devices, one or more output devices, and/or one or more user computing devices. The wireless hub may comprise one or more processors; and memory storing instructions that, when executed by the one or more processors, cause the wireless hub to perform one or more operations. The wireless hub may receive, from at least one of the input devices, a data stream. The data stream may include one or more of audio signals, video signals, metadata (e.g., positional data, orientation data, data associated with NFC devices, clock synchronization), command parameters, or the like. The data stream may be processed by a user computing device, the wireless hub, on a tablet device, and/or a cloud computing device. The wireless hub may send processed data from the data stream to at least one of one or more user devices and/or at least one of one or more output devices. For system setup, the wireless hub may receive, from at least one of the input devices or output devices, a request to establish a connection. The wireless hub may, based on the request, send an indication of acceptance of the connection to the at least one of the plurality of input devices. The wireless hub, and associated devices in the audio system, may communicate with other devices via one or more industrial, scientific, medical (ISM) bands, WiFi, DECT, RF, customized RF technologies, Bluetooth and the like. The wireless hub may transmit audio signals using certain communication protocols while also transmitting control or other data signals using other communication protocols.

The wireless hub may comprise components for one or more data processing features. The components may include predictive or intelligent processing, such as machine learning or AI driven processing. For example, the wireless hub may perform one or more of: gain adjustment, equalization processing, noise suppression, identification, audio signal detection, instrument detection, denoising, de-reverberation, speech enhancement, localization, instrument enhancement, etc. Processing the audio signal may be based on one or more configuration parameters as input by a user via a user device. The one or more configuration parameters may alternatively or additionally be automatically determined by the wireless hub (e.g., using machine learning). Additionally, the wireless hub map inputs from the plurality of input devices and outputs to the one or more output devices based on user configuration via a user device. These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1A, FIG. 1B, and FIG. 1C show example components in an audio system.

FIG. 2A, FIG. 2B, and FIG. 2C show various example audio system architectures.

FIG. 3 shows an example wireless hub and associated devices in an audio system.

FIG. 4A, FIG. 4B, and FIG. 4C show example operation of a microphone and a wireless hub.

FIG. 4D shows an example method of operation of a wireless hub.

FIG. 5 shows an example operation of a charging dock.

FIG. 6 shows an example communication system.

FIG. 7A, FIG. 7B, and FIG. 7C show examples of a wireless audio system as applied for various applications.

FIG. 8A, FIG. 8B, and FIG. 8C show example systems with integrated video recording and/or streaming capability.

FIG. 9A, FIG. 9B, and FIG. 9C show example operation of an audio system.

FIG. 10 shows an example method of signal processing associated with an audio system.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure. It is noted that various connections between elements are discussed in the following description. It is noted that these connections are general and, unless specified otherwise, may be direct or indirect, wired or wireless, and that the specification is not intended to be limiting in this respect.

### Overview

Audio systems often comprise a chain of discrete subcomponents, each configured to perform a specific audio processing functionality. For example, the subcomponents may include microphones, receivers, mixers, amplifiers, speakers, personal monitoring devices, musical instruments, general-purpose computing devices, etc. As an example, a system may receive audio from one or more microphones, and process the audio via a receiver, a mixer, and/or amplifier(s), prior to outputting the audio via one or more speakers. Such a system is often hardwired (e.g., via XLR connections) limiting its flexibility. Larger systems, that may often comprise a plurality (e.g., dozens) of microphones and speakers, interspersed with multiple amplifiers and speakers, may be complex to set-up, use, dismantle, and/or troubleshoot.

For example, an audio system may comprise one or more capture devices (e.g., audio capture devices such as microphones, audio devices, and the like), output from which may be connected (e.g., via cables) to a device that may amplify and/or trim the output. The amplified/trimmed signal may then be fed to one or more audio processing devices (e.g., an audio mixer) that may be used to consolidate multiple audio signals, process the signals (e.g., perform equalization, add effects, adjust levels, etc.) and provide output via one or more output channels. The use of multiple devices in the system may require careful consideration of compatibility between the devices and may result in added complexity due to the use of wired connections/adapters to connect the devices. This may be challenging for a novice user.

Further, traditional audio systems, as put together at a location, may only be meant to perform a specific task. For example, a recording system that comprises multiple microphones capturing audio input that is meant to be processed and stored locally may not be easily repurposed for other associated applications (e.g., live-streaming audio, outputting audio for in-location audience) without substantial modification to its architecture. As a result, a single location may often have multiple audio systems, each configured for a specific task, adding to cost, complexity, and redundancy. Moreover, a single location may lead to confusion around duplicity of controls, such as gain, trim, attenuation, EQ compression, and the like.

Various examples herein describe an audio system comprising a wireless hub that may be connected to one or more other capture devices (e.g., audio capture devices such as microphones, speakers, musical instruments and/or instrument outputs, transmitters, receivers, transceivers, computing devices, video capture devices, where the capture devices may be wired or wireless, etc.). The wireless hub may be flexibly configured (e.g., via an associated computing device, or automatically within the capabilities of the wireless hub) to receive audio input from one or more microphones (and/or one or more other audio sources) and send the audio out to one or more other devices (e.g., speakers, user computing devices, streaming devices, etc.). In addition, the user computing device may comprise applications for enabling audio processing tasks (e.g., mixing, noise reduction, equalization (EQ), recording, live-streaming, local sound/speaker reinforcement, primary and secondary options, etc.) reducing the requirement for multiple external special-purpose devices. In some examples, the user computing device may serve as an interface to a user application (e.g., audio conferencing, video conferencing, audio recording, Internet live streaming, VR and spatial computing devices, gaming consolers, and the like). In one or more examples, the wireless hub may be integrated into an audio device (e.g., a microphone, speaker, a computing device, or any other input/output device). In this manner, an integrated approach, as described herein, may simplify setting up/modifying the system, enhance system flexibility, and improve overall user experience.

Example embodiments of the present disclosure reduce overall complexity (e.g., space saving, freedom of movement, channel limitations) of an audio system by eliminating wires and wired connections. Example embodiments provide for reduction in system complexity as well as increased flexibility for systems involving, for example, three or more wireless input channels or connections and one or more (e.g., two, three, etc.) wireless output channels or connections.

Example embodiments of the present disclosure advantageously provide for a wireless hub having multiple wireless input connections and multiple wireless output connections that can wireless receive audio signals, process the audio signals, and wirelessly transmit the processed audio signals in a short enough time (e.g., minimal latency) such that the system of devices is suitable for live sound. For example, the time it takes for the audio signals to be transmitted by a capture device to the wireless hub, the audio signals to be processed by the wireless hub, and the processed audio signals to be wirelessly transmitted to and received by one or more output devices (e.g., wireless speakers) is short enough such that live sound is supported. In some examples, the aforementioned duration (e.g., 2 wireless hops plus processing) is less than 5 ms, less than 10 ms, less than 15 ms, or less than 20 ms.

### Example Embodiments

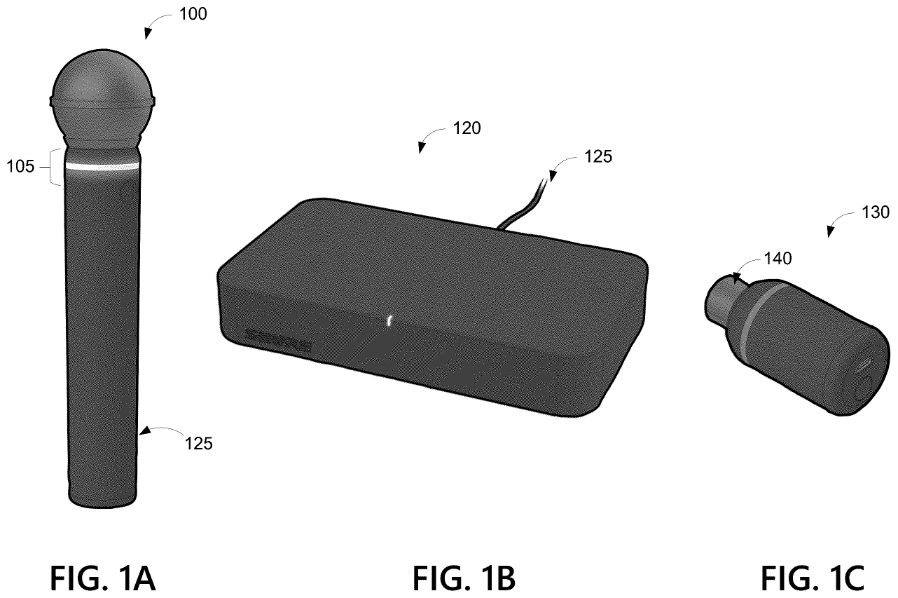

FIG. 1A, FIG. 1B, and FIG. 1C show example components in an audio system. An audio system may comprise one or more microphones 100 (as shown in FIG. 1A), a wireless hub 120 (as shown in FIG. 1B), and/or one or more wireless speaker adapters 130 (as shown in FIG. 1C). The audio system may additionally comprise one or more control devices (e.g., user interfaces, smartphones, tablet computers, remote control devices, etc.) configured to control/operate the various components of the audio system. It will be appreciated that, while examples herein are described with respect to audio signals or audio data, embodiments are applicable to the use of a data stream of one or more of audio signals, video signals, metadata (e.g., positional data, orientation data, data associated with NFC devices, clock synchronization data, etc.), command parameters, or the like, without departing from the scope of the present disclosure.

The microphone 100 may comprise a light ring 105 that may be activated and/or deactivated responsive to various triggers, as further described herein. The light ring 105, in at least one arrangement, may be located along a perimeter/circumference of a handle 125 of the microphone, as shown in FIG. 1A. In other arrangements, the microphone 100 may comprise one or more lighting devices arranged in any other manner. Lighting devices integrated with the microphone 100 may comprise one or more light emitting diodes (LEDs), LED arrays, and/or any other type of light emitting devices.

The wireless hub 120 may be powered via a power cord 125 (e.g., that may be connected to a wall outlet) and/or may be battery powered. In an arrangement, the wireless hub 120 may comprise a rechargeable battery that may be charged via the power cord 125. In some examples, the wireless hub 120 may be powered wirelessly, and/or using power over ethernet (PoE). The wireless hub 120 may receive audio (e.g., from the microphone 100, a user device, etc.), process the audio, and send the audio to one or more speaker adapters 140. In some examples, the user computing device is an input to the wireless hub, which provides for music (or other audio) playback, integration to external use cases (e.g., conferencing, streaming, etc.) either through wireless or wired means, and the like. It will be appreciated that the audio may be processed using the user computing device, a cloud computing device, or other computing device prior to the wireless hub. It will also be appreciated that the wireless hub can receive, process, and transmit data in addition to or other than audio data.

The wireless speaker adapters 130 may be connected (e.g., via connector 140) to speakers that may output received audio (e.g., audio as received from the microphones 100, the wireless hub 120, and/or control devices associated with the audio system). For example, the wireless speaker adapters 130 may receive streaming audio and output the same via one or more corresponding connected speakers. The connector 140 may correspond to a dedicated audio interface (e.g., 3.5 mm connector), a general purpose interface (e.g., a universal serial bus (USB) connector), an XLR connector, or any other type of interface. In an arrangement, the wireless speaker adapters 140 may be integrated with the speakers themselves, and need to be connected via a separate connector/interface. Any quantity of connectors 140 and/or microphones 100 may be used (e.g., may communicate with) with one or more wireless hubs 120. It will be appreciated that, while examples herein are described with respect to wireless speaker adapters, implementations of embodiments herein including wireless functionality integrated into endpoints (e.g., other than adapters) are within the scope of the present disclosure. Such additional integrations provide for flexibility of different types of audio on an endpoint input or output.

In some examples, endpoints of the system may include transceivers (e.g., such that a backchannel is available). By way of such an example, a bodypack with a microphone input may transmit signals to the wireless hub as well as a monitor output (e.g., a headphone jack). By way of further example, a guitar dongle may transmit signals to the wireless hub as well as a monitor output.

It will also be appreciated that embodiments herein may be implemented with multichannel dongles for speaker arrays and multichannel transmitters for microphone arrays without departing from the scope of the present disclosure.

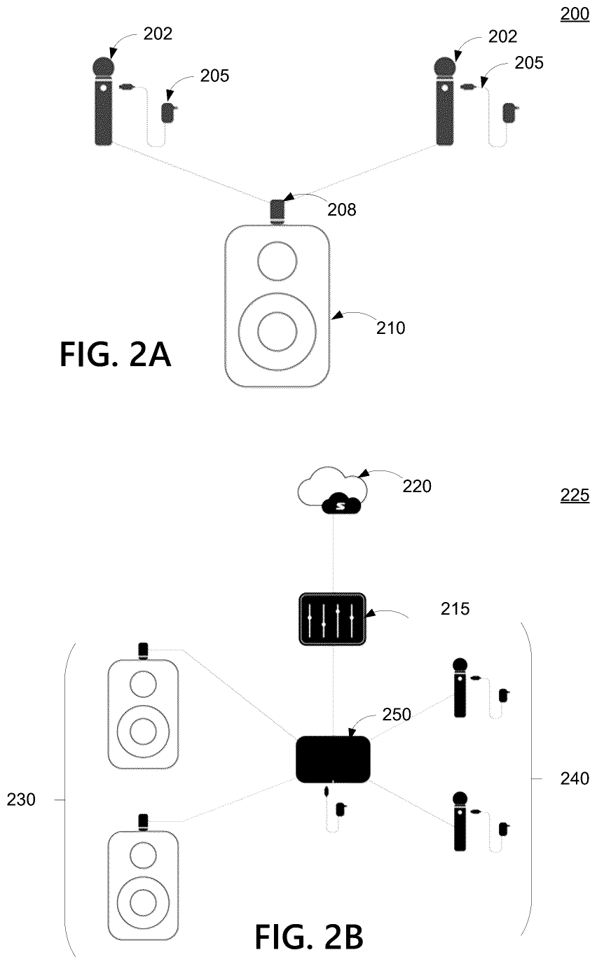

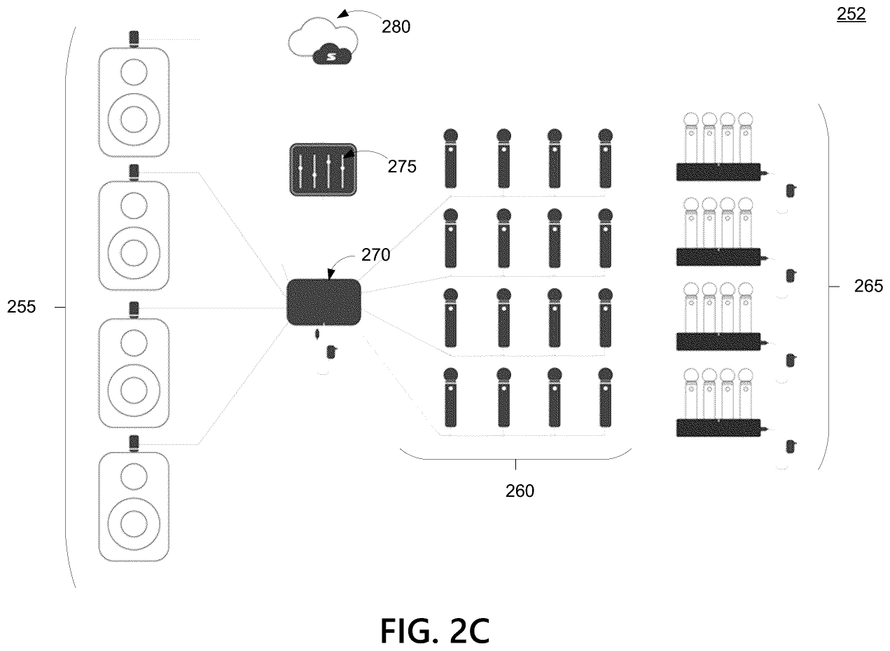

FIG. 2A, FIG., 2B, and FIG. 2C show various example audio system architectures. An example audio system may comprise one or more microphones, a wireless hub, and/or one or more speakers (e.g., connected to the wireless hub and/or the microphones via respective speaker adapters). It will be appreciated that, while embodiments herein are depicted with a wireless hub, implementations of the innovations described herein that include multiple wireless hubs (and other components) are within the scope of the present disclosure. A multi-hub system may include multi-hub interaction control; additionally or alternatively, a multi-hub system may provide for discovery, peer controlling, peer communication, peer interoperability, and more.

FIG. 2A shows an example audio system 200. The audio system 200 may comprise a plurality of microphones 202, a speaker adapter 208, and/or an associated speaker 210. The speaker adapter 208 may establish a connection (e.g., a wireless connection) with one or more of the microphones 202. The one or more microphones 202 may send signals (e.g., audio signals) to the speaker adapter 203 for output via the speaker 210. For example, the speaker adapter 208 may receive the audio signals from one or more of the microphones 202, process the signals (e.g., decode, amplify, etc.), and transfer the signals to the speaker 210 for output.

FIG. 2B shows an example audio system 225. The audio system 200 may comprise a plurality of microphones 240, a wireless hub 250, a plurality of speakers 230, and/or a user device 215. One or more of the plurality of microphones 240 may send signals (e.g., audio signals) to the wireless hub 250. One or more of the plurality of speakers 230 may also connect to (e.g., communicate with) the wireless hub 250 (e.g., via respective associated speaker adapters) and/or receive audio signals that may be input via one or more of the plurality of microphones 240. The user device 215 may comprise a smartphone, laptop, tablet, and/or any other type of device that may be used for one or more audio applications, which may receive and/or process audio signals from the wireless hub 250. The user device 215 may comprise one or more applications that may be used for audio processing and/or control tasks (e.g., mixing, equalization, device volume control, noise cancelation, etc.). The user device 215 (e.g., also referred to herein as a user computing device) may process signals, transmit signals to the wireless hub, transmit a control signal to the wireless hub to alter the operation of signal processing occurring between the capture devices (e.g., microphones) and output devices (e.g., speakers). In another example, the user device 215 may provide a user interface that may be used to configure audio processing at the wireless hub 250. For example, the user interface may be used to input/control the configuration parameters, which may be sent/indicated to the wireless hub 250. The wireless hub 250 may process received audio based on the configuration parameters. The user device 215 and/or the wireless hub 250 may be connected to a computing network 220 (e.g., the internet) for transmission, reception, and/or storage of audio/processed audio (e.g., in real-time). In one or more examples, multiple user devices may be connected to the audio devices in the audio system 225.

In some examples, the wireless hub may determine one or more of the configuration parameters (e.g., for configuring audio processing, including routing and level) based on detecting or sensing an audio source or electrical input (e.g., transducer, guitar, keyboard, etc.) that is providing signals to an input device that then transmits the audio signals to the wireless hub. In some examples, the input device senses the audio source or electrical input and applies some or all appropriate processing. The input device may also, alternatively, sense the audio source or electrical input and apply the appropriate level to the audio signals prior to transmitting them to the wireless hub. The wireless hub may detect or sense the audio input or electrical input and determine the appropriate level and routing for the associated received audio signals. The wireless hub may determine configuration parameters using AI/ML techniques (e.g., using a trained machine learning model or neural network) and/or based on a detected/sensed input device, source, intended destination output device, and/or known or detected use case or application.

In some examples, the wireless hub may generate and transmit control signals to other devices (e.g., user computing devices, input devices, output devices) to instruct, trigger, or alter operation of signal processing (or other processes) occurring therein.

FIG. 2C shows an example audio system 252. The audio system 252 may comprise a plurality of microphones 260, a wireless hub 270, a plurality of speakers 255, microphone charging docks 265, and/or a user device 275. One or more of the plurality of microphones 260 may send signals (e.g., audio signals) to the wireless hub 270. One or more of the plurality of speakers 255 may also connect to (e.g., communicate with) the wireless hub 270 (e.g., via respective associated speaker adapters) and/or receive audio signals that may be input via one or more of the plurality of microphones 260. The wireless hub 270 and the user device 275 may be similar to, and/or perform similar functions as, the wireless hub 270 and/or the user device 215, respectively, as described with respect to FIG. 2B. The user device 275 and/or the wireless hub 270 may be in communication with and/or connected to a computing network 280 (e.g., the internet) for transmission, reception, and/or storage of audio/processed audio (e.g., in real-time). In one or more examples, multiple user devices may be in communication with and/or connected to the audio devices in the audio system 252.

It will be appreciated that, while FIG. 2C depicts a microphone charging dock, implementations of innovations herein where the wireless hub and charging docks are combined into a device that supports both wireless communication and charging are within the scope of the present disclosure.

The audio system 252 may additionally comprise one or more charging docks 265 that may be used to charge batteries, integrated with the microphones 260, for wireless operation. Other wireless charging systems may be used. For example, a charger may be integrated with a microphone stand which may configured to charge the microphone when it is placed on the stand. A wireless charger may comprise a mat with integrated charging coils that may generate a magnetic field. When an audio device is placed on the mat, the magnetic field may be picked up by receiving coils in the audio device and converted to a voltage for charging.

One or more of the devices shown in FIGS. 2A-2C (e.g., microphones, wireless hubs, speaker adapters, and/or speakers) may be battery-powered and/or powered via a wall outlet. For example, an adapter (e.g., adapter 205 as shown in FIG. 2A) may be used to power a device via a wall outlet and/or charge an integrated rechargeable battery of the device (e.g., for wireless operation). The adapter may be connected to a device in an audio system via a USB connector, or any other type of connector.

One or more of the devices shown in FIGS. 2A-2C (e.g., microphones, wireless hubs, speaker adapters, and/or speakers, or other devices herein) may be wirelessly powered. For example, a microphone stand may be integrated with power transmission devices (e.g., one or more coils) that may wirelessly transfer power for microphone operation. Clipping and/or placing a microphone on the stand may wirelessly transfer power (e.g., inductively) to the microphone as required for its operation. Similarly, a mat may be integrated with one or more coils for wireless power transfer. Speakers (and/or other audio devices), placed on the mat, may be inductively powered via the one or more coils. One or more of the devices herein may be powered using power over ethernet (POE).

With reference to example audio systems FIGS. 2A-2C, one or more functions of a wireless hub (e.g., as described with respect to FIGS. 2B and 2C) may be performed by one or more speakers or output devices (e.g., speakers 210, 230, 255). For example, with reference to FIG. 2A, the speaker 210 may have an integrated module configured to provide the functionality of a wireless hub. The module may establish and maintain a direct connection to the microphone(s) 202, receive audio signals from the microphone(s), process the audio signals (e.g., based on one or more configuration parameters), and/or output the processed audio via the speaker 210. In one or more examples, the integrated module may additionally connect to one or more other output devices (e.g., speakers) for outputting processed audio. Further, the audio system 200 of FIG. 2A may also comprise one or more user devices performing one or more functionalities as described above with respect to user devices 215, 275.

In some examples, one or more functions of a wireless hub may be performed by one or more capture devices or microphones. In such examples, the integration of one or more functions of the wireless hub into a capture device provides for elimination of extra or extraneous hardware in smaller systems.

In some examples, one or more devices herein (e.g., capture devices, computing devices, output devices, etc.) may be enabled for peer-to-peer operation such that one or more capture devices may be pre-paired with one or more output devices for direct interactions.

Generally, an audio latency for signal transmission and processing, from a microphone to a speaker via a wireless hub, may be sufficiently low for many applications (e.g., public address applications). Audio latencies for a typical transmission from a microphone to a speaker via a wireless hub may of the order of 15 ms (or more, for example, depending on a processing latency). However, this delay may be too high in at least some applications. For example, in a studio setup where a performer needs to monitor output sound, the performer may use headphones/an earpiece to listen in. In this scenario, an audio latency of less than 10 ms may be desirable. A transmit/processing time from a microphone to the headphones via the wireless hub may introduce unwanted delay for the performer. To reduce the delay, the system may enable the wireless hub to be “short-circuited” out of the chain. In other words, the audio signal may be directly provided from the microphone to the headphone, thereby reducing the delay. That is, a direct transmission path may be configured between an input or capture device and an output device. In such examples, the wireless hub may optionally transmit to the output device control signals (e.g., instructions) regarding processing or mixing that should take place at the output device. Direct transmission from the microphone to an output device, such as the headphone, may be configured during an initial connection procedure of the output device.

In some examples herein, desired latency for any given application (e.g., live sound, streaming, karaoke, conferencing, etc.) may be achieved through a combination of hardware configuration as well as software-enabled logic. For example, the wireless hub may include support for proprietary RF transmission protocols to provide for low latency for live sound (e.g., a duration of less than 20 ms/15 ms/10 ms/5 ms from input device to output device, inclusive of processing). In some examples, certain types of processing that may otherwise have been performed by a wireless hub may be offloaded to the input device, the output device, another wireless hub, or some combination of them in order to achieve the desired latency for the use case or application. A wireless hub may determine that certain processing should take place at the output device, and send control signals to the output device to instruct the output device to perform the appropriate processing. The wireless hub may also, separately or in conjunction with other devices for performing processing (e.g., input device(s), output device(s), user computing device(s), other wireless hubs), determine that audio quality or other parameters may be compromised or adjusted in order to meet a latency requirement. In providing all of these capabilities, the wireless hub as disclosed herein can perform and direct processing tasks to ensure that the desired latency is delivered without over complicating the required equipment.

A wireless hub may have a limited bandwidth to receive signals from audio input devices (e.g., microphones). For example, as shown in FIG. 2C, the wireless hub 270 may be able to simultaneously receive input from a maximum of 16 microphones (or any other quantity of microphones), simultaneously. However, the wireless hub may be linked to a larger number of microphones, exceeding the maximum number of microphones from which it may simultaneously receive input. To facilitate this, the wireless hub may assign a channel to each microphone from which it may receive input. The wireless hub may drop a channel assignment for a microphone from which it has not received any input (e.g., above a threshold volume magnitude) for a predetermined time period. The wireless hub may assign a channel for another microphone (e.g., that has not been currently allocated a channel), for example, if the other microphone sends an indication that it is being used (e.g., if the microphone receives an audio input above a threshold magnitude). In some examples, there may be a maximum number of actively transmitting devices (e.g., 16) while others may be in a sort of standby mode with the wireless hub such that they are ready to transmit. In some examples, one or more additional wireless hubs may be deployed to support additional devices. Each wireless hub may include a memory list of previously recognized devices.

In examples where multiple wireless hubs are included in an audio system according to embodiments herein, one or more of the multiple wireless hubs may be able to discover one another (e.g., based on proximity, shared network, pairing techniques) and may be aware of one another. The use of multiple wireless hubs provides for range extension, additional channels, additional processing, parallel processing (e.g., offloading certain processing from one wireless hub to another to free up resources that are needed in parallel by the first wireless hub), and the like.

The wireless hub may connect to one or more audio devices via an external communication network (e.g., the computing network 220, the computing network 280, internet, local area network (LAN), etc.). This facility may considerably increase a footprint of the system, enabling devices to transmit and receive audio from one or more local devices and/or distant devices (e.g., remotely located devices such as connected via the Internet). The connection to the external communication network may enable real-time transmission of audio to external/remote devices/networks. In one example scenario, this may be leveraged to live-stream audio, as received and processed by an audio system, to remote listeners. The network connection may also be used for remote storage of raw/processed audio, the use of cloud-based processing of captured audio, or other cloud-based computing functionality. In some examples, connection to an external communication network and the functionality associated therewith may be provided by a computing device, in connection with or as opposed to the wireless hub. Such offloading of the external network communication to a computing device may provide for increased scope and fewer limitations on wireless hub functionalities and connections.

Communications between the devices in an audio system may be via any proprietary or non-proprietary communication standards. In an example, the communication between the devices may be via channels or connections that are designated as industrial, scientific, and medical (ISM) bands defined by the International Telecommunication Union (ITU) Radio Regulations (e.g., a 2.4 GHz-2.5 GHz band, a 5.75 GHz-5.875 GHz band, a 24 GHZ-24.25 GHz band, and/or a 61 GHZ-61.5 GHz band, etc.). Additionally, or alternatively, the communication between the devices in the audio system may be via (e.g., one or more channels within) a very high frequency (VHF) band (e.g., 30 MHz-300 MHz band) and/or via (e.g., one or more channels within) an ultra high frequency (UHF) band (e.g., 300 MHz-3 GHZ). Additionally, or alternatively, the communication between the devices in the audio system may be via DECT, RF bands, Bluetooth protocol, an Institution of Electrical and Electronics Engineers (IEEE) 802.11 WIFI protocol, a 3rd Generation Partnership Project (3GPP) cellular protocol, a local area network (LAN) protocol, a hypertext transfer protocol (HTTP), and the like, without limitation.

While FIGS. 2A-2C (and elsewhere in the specification), inputs to a wireless hub are illustrated/described as being from one or more microphones and outputs from the wireless hub are illustrated as being to speakers or headphones, the specification is not intended to be limiting in that aspect. Inputs to the wireless hub may be any audio, electrical, and/or electromagnetic signals (e.g., originated from any input devices and/or sources) that may be processed by the wireless hub. Outputs from the wireless hub may be any audio, electrical, and/or electromagnetic signals that may be played back via output devices, stored, and/or processed by other devices.

Input devices that may provide input to the wireless hub may comprise one or more of: wireless microphones, wearable packs (e.g., beltpacks) associated with microphones, wireless headsets integrated with a microphone, electronically-readable memory comprising stored audio, a computing device (e.g., smartphone, tablet) with integrated microphones, and/or a transceiver associated with a musical instrument. Output devices that may be connected to the wireless hub, and receive output from the wireless hub, may comprise one or more of: speakers, wearable packs (e.g., beltpacks) associated with headsets, a wireless headset, a user computing device, an electronically-readable memory, a transceiver associated with a musical instrument, an output interface (e.g., an XLR connector, USB connector, 3.5 mm connector, etc.), a server associated with a computing network (e.g., local network, public network such as the Internet), a computing device (e.g., smartphone, tablet) with integrated speakers or connected headphones, etc.

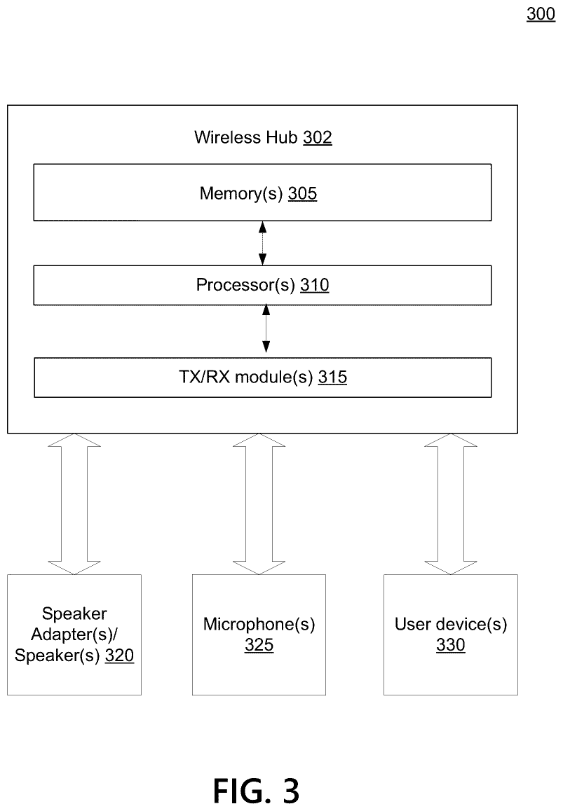

FIG. 3 shows an example wireless hub and associated devices in an audio system 300. The example wireless hub 302 may correspond to the wireless hub 120, 250, or 260. The wireless hub 302 may comprise one or more of processor(s) 310, transmit/receive (TX/RX) module(s) 315, and/or memory 305. One or more data buses may interconnect the processor(s) 310, the TX/RX module(s) 315, and/or the memory 305. The wireless hub 302 may be implemented using one or more integrated circuits (ICs), software, or a combination thereof, configured to operate as described herein. The memory 305 may comprise any memory such as a random-access memory (RAM), a read-only memory (ROM), a flash memory, or any other electronically readable memory, or the like.

Signals transmitted from and/or received by the wireless hub 302 may be encoded in one or more data units. For example, the processor(s) 310 may be configured to generate data units, and process received data units, that conform to any suitable wired and/or wireless communication protocol. The processor(s) of the wireless hub 302 may be configured to execute machine readable instructions stored in memory 305 to perform one or more operations described herein. The TX/RX module 315 may be configured to send/receive signals (e.g., from speaker(s), speaker adapter(s) 320, and/or microphones 325) using one or more communication protocols (e.g., Bluetooth protocol, an Institution of Electrical and Electronics Engineers (IEEE) 802.11 WIFI protocol, a 3rd Generation Partnership Project (3GPP) cellular protocol, a local area network (LAN) protocol, a hypertext transfer protocol (HTTP), industrial, scientific, and medical (ISM) bands defined by the International Telecommunication Union (ITU) Radio Regulations (e.g., a 2.4 GHz-2.5 GHz band, a 5.75 GHz-5.875 GHz band, a 24 GHz-24.25 GHz band, and/or a 61 GHz-61.5 GHz band, a very high frequency (VHF) band (e.g., 30 MHz-300 MHz band), an ultra high frequency (UHF) band (e.g., 300 MHz-3 GHZ), DECT, RF bands, and the like, without limitation). Audio signals may be transmitted via certain communication protocols while control or other data signals may be transmitted via other communication protocols. In some examples, audio, control, and data signals are transmitted over all of the same communication protocols.

In one or more examples, and as further described herein, the wireless hub 302 may also communicate with one or more user devices (e.g., smartphones, tablet computers, remote control devices, etc.) that may be configured to control operation of the audio system 300. It will be appreciated that the wireless hub may be configured to simultaneously communicate (transmit signals to and/or receive signals from) input devices, output devices, and user computing devices.

Other devices in the audio system (e.g., speaker(s)/speaker adapter(s) 320, microphone(s) 325, user devices 330, etc.) may have an architecture similar to the wireless hub 302. For example, one or more of the other devices in the audio system may comprise corresponding memories, processors, and/or TX/RX modules.

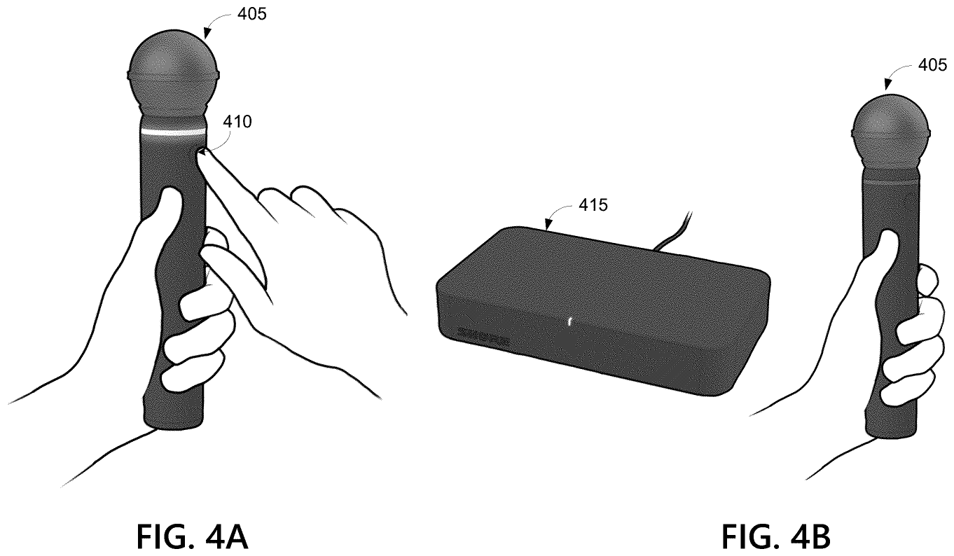

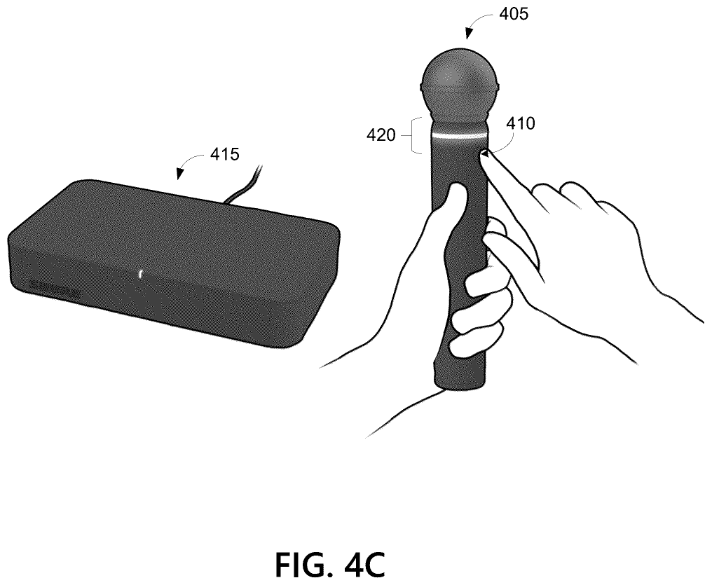

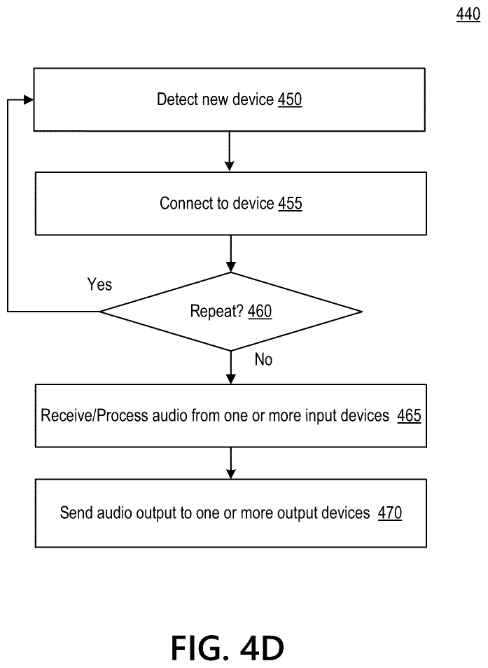

FIG. 4A, FIG. 4B, and FIG. 4C show example operation of a microphone and a wireless hub. As shown in FIG. 4A, the microphone 405 may be configured with a power button 410 that may be activated (e.g., pushed, held down) to activate/turn on the microphone 405. If the microphone 405 is already paired with the wireless hub 415, the microphone 405 may be used to send audio signals to the wireless hub 415 immediately after activation of the microphone.

To establish a connection between the microphone 405 and the wireless hub 415, the microphone 405 may brought to a proximity of the wireless hub 415 (e.g., as shown in FIG. 4B). Further, as shown in FIG. 4C, the power (e.g., or any) button 410 may be activated (e.g., pressed, push down, etc.) for a predetermined period of time (e.g., 2 seconds, 3 seconds, 5 seconds, or any other time duration). Activating the power button 410 (e.g., for the predetermined time duration) may result in the microphone 405 automatically attempting to establish communication with a wireless hub (e.g., the wireless hub 415). For example, the microphone 405, based on the activation of the power button 410 for the predetermined time duration, may send/transmit beacon signals. Additionally, or alternatively, the microphone 405 may comprise an integrated accelerometer which may sense a movement of the microphone (e.g., a user picking up the microphone). Based on the detected movement, the microphone 405 may send/transmit beacon signals. The accelerometer may also be able to detect the microphone being set down on a surface. The use of an accelerometer may advantageously conserve microphone battery life by enabling the microphone 405 to enter a low power mode (e.g., sleep/stand-by mode) or get deactivated when the microphone is set down. It will be appreciated that, while examples herein are described with respect to an accelerometer, other implementations, such as those with magnetometers, IMUs, other sensors, NCF, BLE, DECT, UWB, or the like, are within the scope of the present disclosure. Moreover, such hardware and functionality may be implemented in other devices herein (e.g., capture devices, output devices, and the like).

The microphone 415 may indicate an attempt of communication with a wireless hub, for example, via an integrated lighting device, such as a light ring 420). For example, the light ring 420 may flash with a predetermined frequency (and, optionally, with a predetermined color) while the microphone 415 is transmitting the beacons signals.

The wireless hub 415, based on detecting the beacon signals, may send/transmit handshake signal(s) to the microphone 405 to establish a connection between the wireless hub 415 and the microphone 405. Based on establishing the connection, the microphone 405 may indicate (e.g., via an integrated lighting device, such as the light ring 420) that a connection with the wireless hub 415 has been successfully established. For example, the light ring 405 may be activated (e.g., for a predetermined time duration) and/or may be activated to indicate a specific color (e.g., white, or any other color). Additionally, or alternatively, the microphone 405 may indicate that the connection with the wireless hub 415 has been successfully established via a tone emitted via a speaker integrated with the microphone, and/or via one or more haptic indications (e.g., activation of a vibration motor integrated with the microphone 405). It will also be appreciated that one or more of the devices herein may include displays (e.g., LCD, other display) that are configured to display graphical user interfaces (GUIs), where visual representation of signals can be rendered for observation and/or consumption.

Integrated light(s) and/or vibration motor(s) of a microphone may be used to show other microphone statuses. For example, the microphone may comprise a mute button, activation of which may result in muting the microphone and activation of a mute indicator (e.g., a red LED) on the microphone. A light ring (e.g., the light 420) may indicate a battery status (e.g., low, fully charged, relative level of charge, etc.). For example, a small segment of the light ring may intermittently flash if the integrated battery is determined to have a low charge level. Any other light indication may be used to indicate one or more conditions (e.g., fully charged, on/operation status, mute status, audio level, etc.) Additionally, or alternatively, a vibration motor of the microphone may be activated if the integrated battery is determined to have a low charge level. In some examples, a voice/audio feedback (e.g., via a speaker connected to the audio system, a speaker integrated with the microphone, etc.) may be used indicate a microphone status. For example, the speaker may indicate that the battery is completely charged by outputting a voice notification saying “battery fully charged.” The speaker may indicate completion of a sound check by outputting a voice notification saying “sound check complete.” Any other voice/audio indication may be provided to indicate any other status/message.

While FIGS. 4A-4C describe microphone setup and operation, similar procedures may be applied for one or more other audio devices. For example, a speaker (or any other audio device) may establish a connection with the wireless hub and/or may indicate a status of the speaker (e.g., via integrated lights, vibration motors, voice/audio feedback, etc.), in a manner similar to that described with respect to FIGS. 4A-4C.

In an example arrangement, multiple wireless hubs may be deployed for an audio system. In one such example, a single wireless hub may serve as a parent hub, with other hubs connected to parent hub as child/secondary hubs. The parent hub may be used to configure/add additional secondary hubs to the audio network. Audio devices (e.g., microphones, speakers, etc.) may be added to the secondary hubs, in accordance with various examples described herein. Audio processing may be performed at the parent hub and/or the secondary hubs. The secondary hubs may be connected to/synchronized with the master hub, for example, via beacon signals (e.g., as described above) and/or via external configuration via a user device. In another example, the hubs can be connected as a peer-to-peer (P2P) system without a centralized parent hub.

A communication protocol may facilitate signal exchange between the hubs (e.g., wirelessly) for various purposes. For example, a wireless hub may send signals to other hubs/a parent hub with information identifying the wireless hub (e.g., a wireless hub indicator) and/or devices connected to the wireless hub (e.g., input/output devices, user devices, etc.). Contention protocols may enable the system of wireless hubs and/or associated devices to share an available bandwidth with minimal interference.

In an audio system that comprise multiple hubs, audio devices (e.g., input/output devices, such as speakers, microphones, etc.) may be operable to access the audio system via one or more the wireless hubs associated with the audio system. For example, an input/output device may connect to a wireless hub that is nearest to the input/output device, and/or from which the input/output device senses a strongest received signal power. An infrastructure of audio hubs could be deployed across an environment (e.g., a studio, an auditorium, an office space, campus, etc.). An audio device may be seamlessly associated, dynamically, to any wireless hub automatically. This may also enable a “bring your own device” system to expand and/or manage any quantity of audio devices using the audio system. It will be appreciated that other detection techniques (e.g., manual, button activation, etc.) are within the scope of the present disclosure.

FIG. 4D shows an example method of operation 440 of a wireless hub. At step 450, the wireless hub may attempt to detect one or more other devices (e.g., audio input devices, audio output devices, other wireless hubs, etc.) with which a connection may be established. For example, a beacon protocol may be used to detect audio devices. The wireless hub may (e.g., after being activated, periodically, and/or based on user input via a user interface of the wireless hub) broadcast beacon signals to attempt to establish connection to one or more other devices. A device, receiving the beacon signals, may respond with an acknowledgement signal. Based on receiving the acknowledgement signal, the wireless hub may establish a connection with the device (e.g., step 455). The beacon signal and the acknowledgement signal may comprise respective identifiers associated with the wireless hub and the device, respectively.

As another example, a device (e.g., after being activated, periodically, and/or based on user input via a user interface of the device) may broadcast beacon signals to search for wireless hubs. The wireless hub, based on receiving the beacon signals, may respond with an acknowledgement signal and establish a connection with the audio device (e.g., step 455). The beacon signal and the acknowledgement signal may comprise respective identifiers associated with the device and the wireless hub, respectively.

At step 460, the wireless hub may determine whether to repeat the processes (e.g., steps 450 and 455) for connecting to another device. For example, if the wireless hub detects another device (e.g., based on processes described with respect to step 450), the wireless hub may attempt to connect to the other device (e.g., step 455). If no new device is detected, the wireless hub may continue regular operation (e.g., steps 465 and 470).

At step 465, the wireless hub may receive and/or process received audio from one or more audio input devices or computing devices that are connected to the wireless hub. Processing the audio may comprise performing one or more of mixing, auto-mixing, equalization, device volume control, gain adjustment, noise cancelation, signal detection, environmental detection, localization, separation, de-reverberation, use case detection, audio enhancement, automatic stem generation, AI/ML signal processing, digital signal processing, identification, instrument detection, denoising, speech enhancement, instrument enhancement, routing determination, level determination and adjusting, mixing, automixing, dynamic processing, compression, gating (e.g., dynamics in DSP), etc. The processing tasks may be based on user control (e.g., via a user device 330).

At step 465, the wireless hub may send the processed audio to one or more audio output devices connected to the wireless hub. Establishing connection with new devices (e.g., as described with respect to steps 450 and 455) may proceed simultaneously with receiving, processing, and output of audio.

The various methods, devices, and systems as described herein may enable input and output devices to automatically connect to a wireless hub. The wireless hub may be a device with integrated functionality associated with receiving, processing, and outputting audio. The wireless hub may perform one or more operations associated with a wireless microphone receiver, audio mixer and audio transmitter to wireless output devices (e.g. loudspeaker). Wireless connectivity between the various devices may eliminate the need for physical audio connection of cables between microphones, mixers, loudspeakers, and/or other components in an audio system.

The wireless hub may provide advantages related to flexibility of application, and user friendly, intuitive operation. Wireless audio devices may be automatically discoverable for inclusion in the wireless audio network (e.g., using a beacon and/or handshake protocol as described herein). Wireless devices may be seamlessly integrated based on an application of the audio network. For example, if an existing audio network needs to be modified for large audiences, local reinforcement speakers (e.g., portable, or pre-existing in the audience space) may be quickly integrated via the wireless hub. Further, the wireless hub may provide connectivity to a wider computer network (e.g., the internet), such that the audio network may be used for streaming and recording to remote audiences without the need to connect to additional, redundant or separate audio systems for internet connectivity.

The wireless hub may also perform one or more processing operations. For example, the wireless hub may automatically account for improper volume, placement, and/or setup of an audio source by correcting the volume in the audio chain (e.g., auto-mixing).

The audio network may be configured with a simplified user interface for viewing status, and enabling control and configuration of the audio network. This may provide the ability for all devices to be known on a network, and provide user with information regarding mapping of audio inputs to audio outputs (e.g., mapping from an audio source, such as a microphone, to an audio destination, such as a speaker). For example, a user device (e.g., a tablet, smartphone, laptop, etc.) may be connected to the wireless hub and may be used to configure, via a user interface software, operation and provide information relating to the wireless hub. One or more devices of the audio network may be controlled and operated via the user interface software in real time.

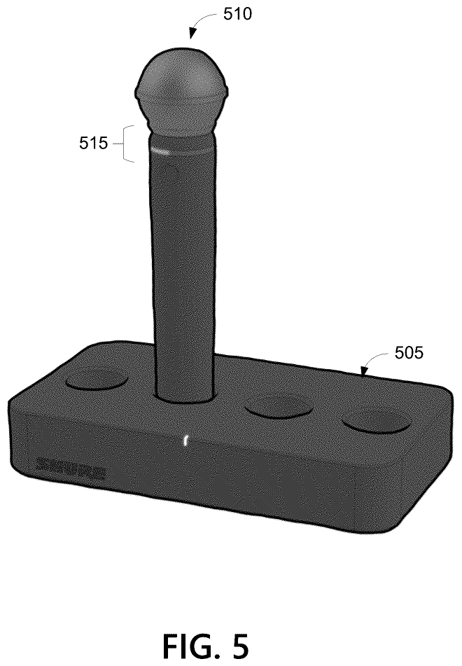

FIG. 5 shows an example operation of a charging dock. The charging dock 505 may be used to charge an integrated battery of a microphone. As shown in FIG. 5, a microphone 510 may be charged by placing it on/attaching it to the charging dock. Placing the microphone 510 on the charging dock may cause attachment of a charging port (e.g., a USB connector), located on the charging dock, to another port located on the microphone 510.

In another example, a more integrated approach may be used for wireless charging. For example, a charging dock may be integrated with a speaker and/or a wireless hub. A microphone may be charged by placing it on, or attaching the microphone to, the speaker/wireless hub. Removing the microphone from the speaker/wireless hub may activate/turn on the microphone and/or an associated audio system.

The battery status (e.g., a current charge/fill level) may be indicated via a light ring 515 of the microphone 510. For example, the light ring 515 may incrementally fill up/activate in proportion to a current battery fill status/energy stored in the battery of the microphone 510. A full battery may be indicated by the entire light ring being activated (e.g., in a specific color, such as green).

In an example, removal of the microphone 510 from the charging dock may result in the microphone 510 being deactivated/powered off. In an example, removal of the microphone 510 from the charging dock may result in the microphone 510 being activated, connected to a wireless hub, and ready for use. In an example, removal of the microphone 510 from the charging dock may result in the microphone 510 being activated but muted.

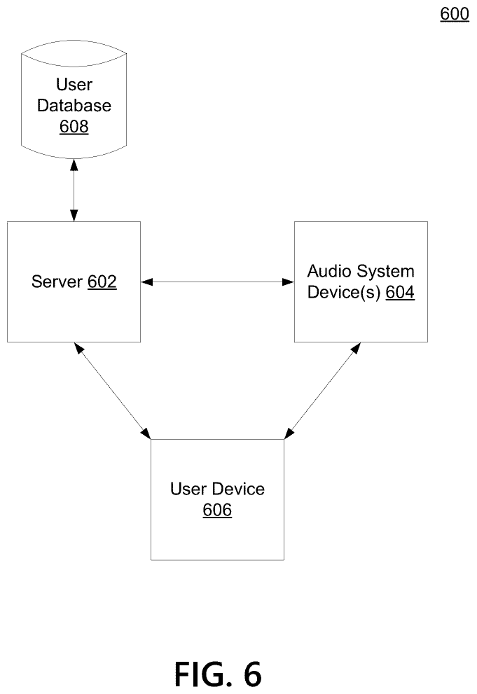

FIG. 6 shows an example communication system 600. The example communication system 600 may comprise one or more audio system device(s) 604, a user device 606, a server 602, and/or an associated database 608. The devices in the communication system 600 may be configured to transmit/receive/exchange/share information/signals via hardware and/or software interfaces using one or more communication protocols. The communication protocols may be any wired communication protocol(s), wireless communication protocol(s), and/or one or more protocols corresponding to one or more layers in the Open Systems Interconnection (OSI) model (e.g., a LAN protocol, an IEEE 802.11 WIFI protocol, a 3GPP cellular protocol, an HTTP, a Bluetooth protocol, etc.).

The one or more audio system device(s) 604 may corresponding to one or devices in the audio systems 200, 225, and 252, as described with respect to FIG. 2A, FIG. 2B, and/or FIG. 2C. For example, the one or more audio system device(s) 604 may comprise one or more input devices (e.g., microphone(s)), one or more output devices (e.g., speaker(s)), one or more speaker adapter(s), and/or wireless hub(s).

The user device 606 may be a computing device (e.g., desktop computer, laptop computer) or mobile computing device (e.g., smartphone, tablet). For example, the user device 606 may have an architecture similar to that of the wireless hub 302 as described with respect to FIG. 3. The user device 606 may be configured to host, execute, and/or otherwise provide one or more applications for audio system control, audio processing, user authentication, etc.

The server 602 comprise one or more computing devices and/or other computer components (e.g., processors, memories, communication interfaces). For example, the server 602 may have an architecture similar to that of the wireless hub 302 as described with respect to FIG. 3. The server 602 may be configured to host, execute, and/or otherwise provide one or more applications for user device authentication, linked audio device management, device control, etc. The database 608 may comprise one or more electronic memory devices such as tape drives, hard disk drives, optical disks, removable storage media, solid-state memory, RAM, etc.

The user device 606 may present a user interface (e.g., via an installed application, or a web interface) that may be used to control operation of the audio system device(s) 604. A user, associated with the user device 606, may authenticate themselves, via the server 602, to enable control of the one or more audio system device(s) 604. For example, the user may input, via the user interface on the user device 606, an account identifier and password associated with a user account. The account identifier and the password may be sent to the server 602 for authentication of the user device 606.

The server 602, after authenticating the user device 606, may query a user database 608 to determine the one or more audio system device(s) 604 that are linked to the user account. The server 602 may send an approval notification to the user device 606 based on authenticating the user device 606. The approval notification may further comprise unique device identifiers associated with each of the one or more audio system device(s) 604. Based on receiving the approval notification and the unique device identifiers, the user device 606 may connect to/communicate with the one or more audio system device(s) 604 and/or control operation of the one or more audio system device(s) 604. The user device 606 may also connect/link new audio devices to the user account (e.g., via the application, using the procedure described with respect to FIGS. 4A-4C, etc.).

In an example arrangement, the user device 606 may directly communicate with/control (e.g., via Bluetooth, IEEE 802.11 protocol(s), etc.) the one or more audio system device(s) 604 based on receiving the approval notification. Additionally, or alternatively, the user device 606 may communicate with/control the one or more audio system device(s) 604, via the server 602, based on receiving the approval notification. For example, the user device 606 (e.g., based on user input via the user interface) may send a notification, to the server 602, to control (e.g., mute) one of the one or more audio system device(s) 604. Based on the received notification, the server 606 may send, to the one of the one or more audio system device(s) 604, a command (e.g., a mute command) to the one of the one or more audio system device(s) 604. The user device 606, after authentication, may also be used to link additional audio devices to the user account.

The user database 608 may store other types of user information. For example, the user database 608 may indicate a service level associated with a user account. This may be particularly useful for a subscription-based service as may be provided by an audio system manufacturer. A higher service level may be associated with an ability to connect a higher quantity of devices to an audio system, a higher quantity and/or level of service(s), remote software/firmware updates, remote customer service/troubleshooting, enhanced audio processing options, etc.

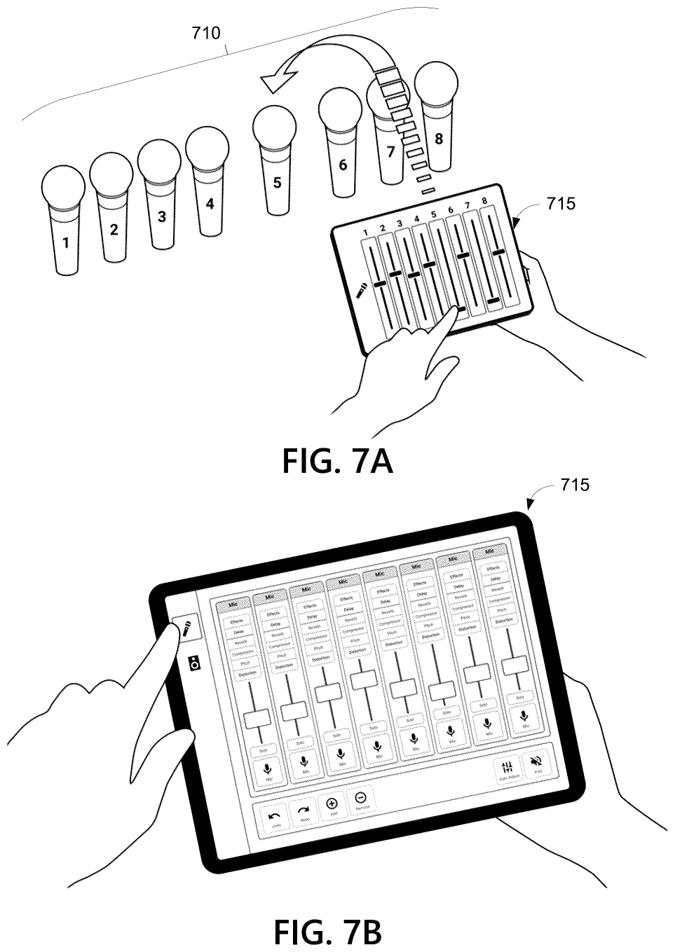

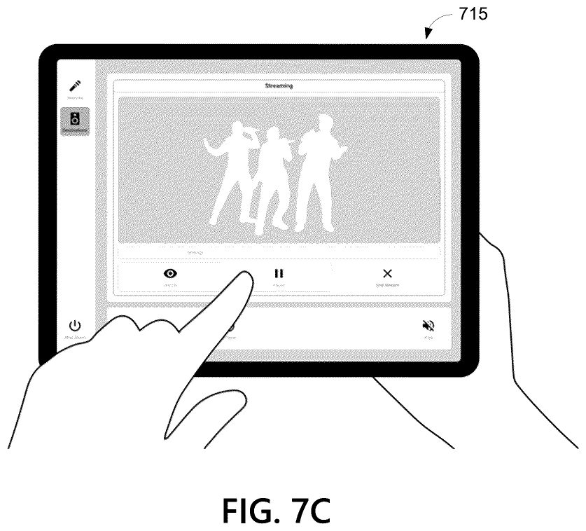

FIG. 7A, FIG. 7B, and FIG. 7C show examples of a wireless audio system being applied for various applications (e.g., livestream, recording, live performance, mobile and/or computer use, etc.). Example user interfaces as shown in FIGS. 7A-7C may be presented on a user device 715 by an application installed on the user device 715. The example user interfaces as shown in FIGS. 7A-7C may be presented on a user device 715, for example, based on successful authentication of a user account associated with the audio system (e.g., via a server as described with respect to FIG. 6). FIG. 7A shows an example user device 715 as used to wirelessly control one or more of a plurality of audio devices 710 (e.g., microphones 1-8). FIG. 7B shows additional detail of a user interface as presented on the user device 715. In an arrangement, the user interface may present separate, dedicated controls associated with each of the audio devices 710. For example, the user interface may present options to individually control a volume of the audio devices 710, mute/unmute the audio devices 710, add labels to the audio devices 710, apply effects (e.g., sound effects, lighting effects, etc.) to the audio devices 710, perform one or more processing functions (e.g., mixing, equalization, noise reduction, etc.), and/or the like.

In some examples, the identity of a person, instrument, or other device/entity can be detected, using AI/ML techniques, and audio or signal processing is deployed according to saved preferences or other information associated with what or whom has been detected/identified. Such automatic processing (e.g., audio, speech, or otherwise) may include a profile associated with a person (e.g., the person is registered, their preferred settings are saved (EQ, compression, audio enhancement, gain, etc.)), and preferring settings may be automatically deployed whenever the person approaches a capture device (e.g., steps up to the microphone).

The user interface may be used to identify a specific audio device associated with the user device 715. For example, each of the audio devices 710 may be associated with a corresponding icon as presented in the user interface. The user clicking/touching an icon on a screen of the user device 715 may result in an audio device associated with the icon exhibiting an indication (e.g., a flashing light, a light of a specific color, an audible ring, a vibration, etc.). For example, selecting an icon corresponding to microphone 4, may result in activation of a ring light of the microphone. In an example, each of the audio devices 710 may be indicated with a different color in the user interface. Selecting an icon corresponding to an audio device may cause activation of a light of the audio device with the corresponding color.

Based on receiving a user input/command via the user interface, the user device 715 may send an appropriate signal to a corresponding audio device. For example, the user device 715, based on receiving a mute command for an audio device, may send (e.g., via Bluetooth, IEEE 802.11 protocol(s), etc.) a signal to cause the audio device to be muted.

FIG. 7C shows another example application of a user interface as presented on the user device 715. The user interface may be used to record inputs as received by various audio devices 710 (e.g., microphones) and/or stream the received input via Internet. For example, the user device 715 may be linked to a wireless hub (associated with the audio devices). The wireless hub may receive input audio from the audio devices 710 and transmit the same the user device 715. The user device 715 may store the received audio to memory and/or stream the audio via the Internet to other devices.

In some examples, one or more cameras associated with the user device 715 and/or one or more external cameras may be used to simultaneously record/stream video. The combined audio/video signal may be recorded and/or streamed via the Internet. In one or more examples, the wireless hub may be configured to communicate with/discover/receive input from video devices (e.g., cameras) in addition to the audio devices 710. The wireless hub may transmit received video feed to the user device for storage and/or streaming.

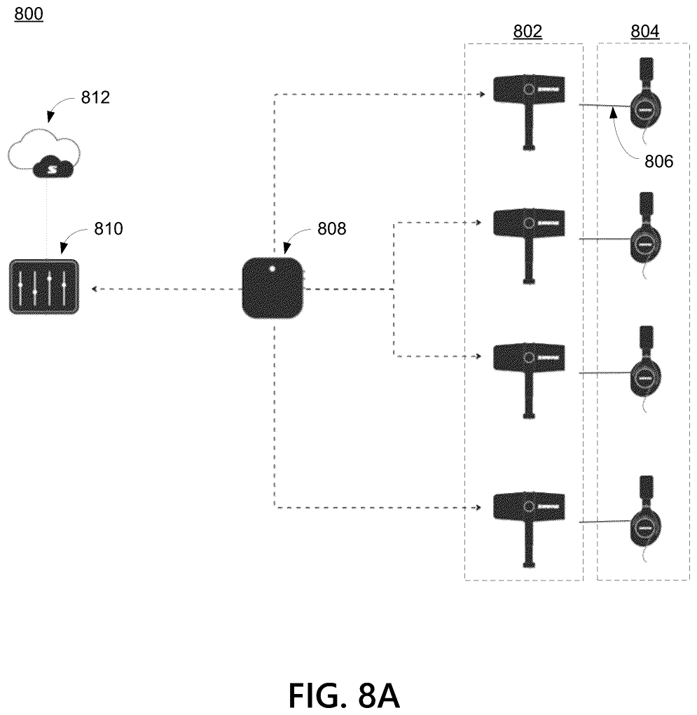

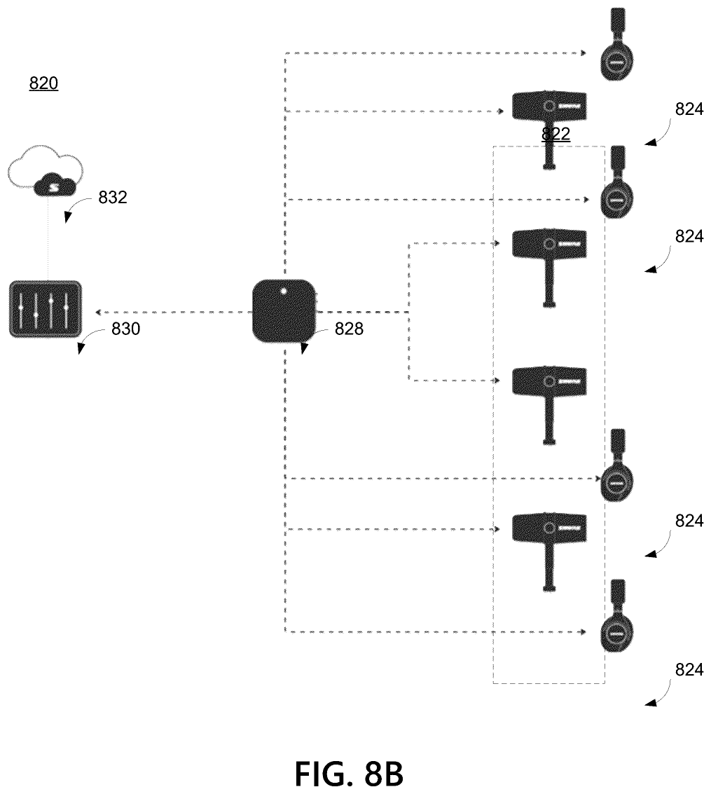

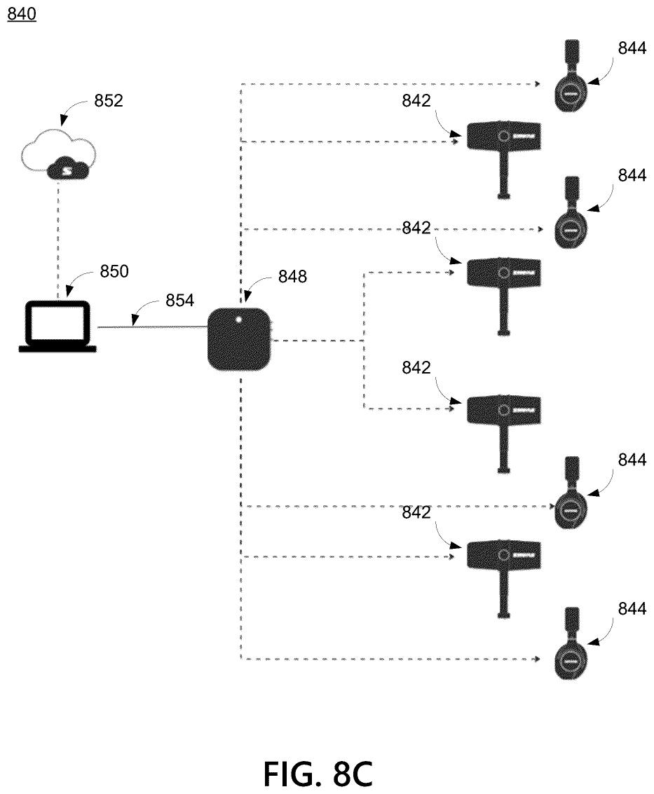

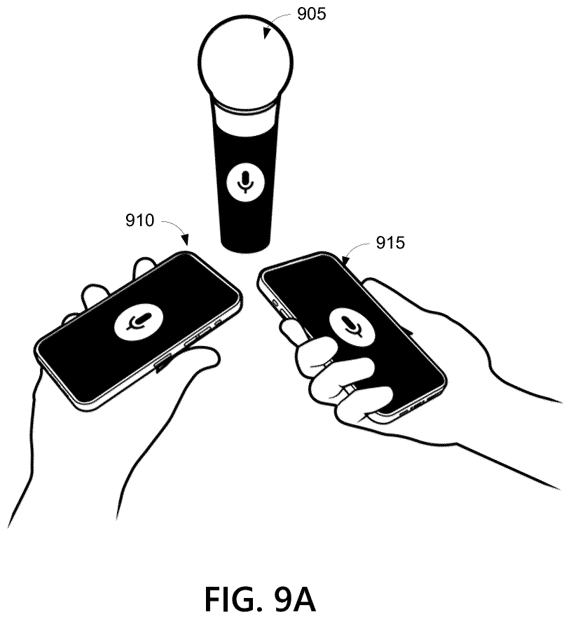

FIG. 8A, FIG. 8B, and FIG. 8C show example systems with integrated recording and/or streaming capability. The example system 800 of FIG. 8A may comprise one or more microphones 802, a wireless hub 808, and/or a user device 810. Each of which may be associated with an output device 804 (e.g., headphone) for audio monitoring. A microphone 802 may be in communication with (e.g., wirelessly connected to and/or connected by one or more wires/cables to) its associated output device 804. The microphone 802 may provide captured audio to its associated output device 804, such as via a direct wired connection 806. In other words, the connection between the output device 804 and the microphone 802 may not involve the wireless hub 808.

One or more microphones 802 may send signals (e.g., audio signals) to the wireless hub 808. The user device 810 may comprise a smartphone, laptop, tablet, and/or any other type of device that may be used for one or more audio applications, which may receive and/or process signals (e.g., audio signals) from the wireless hub 808. The example system 800 may additionally comprise one or more video cameras connected to/in communication with the wireless hub 808. Additionally, or alternatively, the user device 810 may also be connected to and/or integrated with one or more video cameras. The one or more video cameras may be used to send audio and/or video signals to the wireless hub 808 and/or the user device 810 for processing.

The user device 810 may comprise one or more applications that may be used for audio processing, video processing, and/or control tasks (e.g., mixing, equalization, device volume control, noise cancelation, video resolution/bitrate control, etc.). In an example, audio/video processing may be performed at the user device 810. In another example, the user device 810 may provide a user interface that may be used to configure audio/video processing at the wireless hub 808. For example, the user interface may be used to input/control the configuration parameters, which may be sent/indicated to the wireless hub 808. The wireless hub 808 may process received audio and/or video based on the configuration parameters. The user device 810 and/or the wireless hub 808 may be in communication with and/or connected to a computing network 812 (e.g., the internet) for transmission, reception, and/or storage of processed audio/video (e.g., in real-time).

FIG. 8B shows another example system 820 for recording and/or streaming. The example system 820 of FIG. 8B may comprise one or more microphones 822, one or more monitoring devices 824 (e.g., headphones), a wireless hub 828, a user device 830, and/or a computing network 832. The microphones 822, the wireless hub 828, the user device 830, and the computing network 832 may be similar to and/or perform operations similar to those described with the microphones 802, the wireless hub 808, the user device 810, and/or the computing network 812, respectively, as described with respect to FIG. 8A. In contrast to FIG. 8A, however, the wireless hub 828 may (e.g., wirelessly) provide output audio (e.g., as received from the microphones 802 and, optionally, processed by the wireless hub 828) to the one or more monitoring devices 824. The system 820 may additionally comprise one or more video cameras configured to operate in a manner similar to as described with respect to FIG. 8A. For example, the one or more video cameras may send audio and/or video signals to the user device 830 and/or the wireless hub 828.

FIG. 8C shows another example system 840 for video recording and/or streaming. The example system 840 of FIG. 8C may comprise one or more microphones 842, one or more monitoring devices 844 (e.g., headphones), wireless hub 848, a user device 850. The microphones 842, the monitoring devices 844, the wireless hub 848, the user device 850, and the computing network 852 may perform operations similar to those described with the microphones 822, the monitoring devices 824, the wireless hub 828, the user device 830, and/or the computing network 832, respectively, as described with respect to FIG. 8B. A connection between the wireless hub 848 and the user device 850 may be a wired connection (e.g., using a USB communication protocol, or any other communication protocol). The system 840 may additionally comprise one or more video cameras configured to operate in a manner similar to as described with respect to FIG. 8C. For example, the one or more video cameras may send audio and/or video signals to the user device 850 and/or the wireless hub 848.

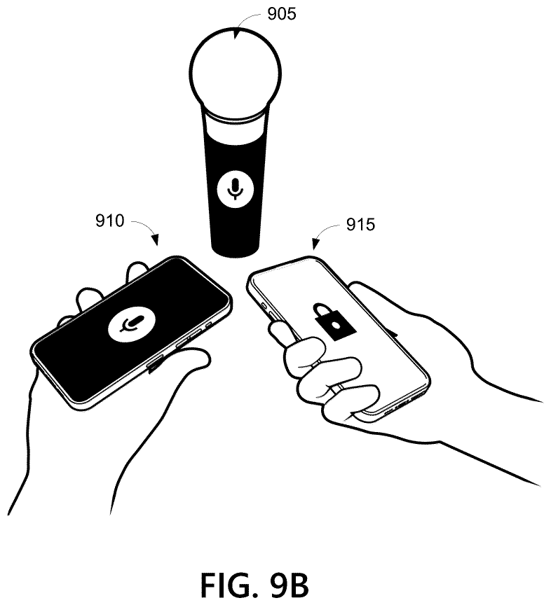

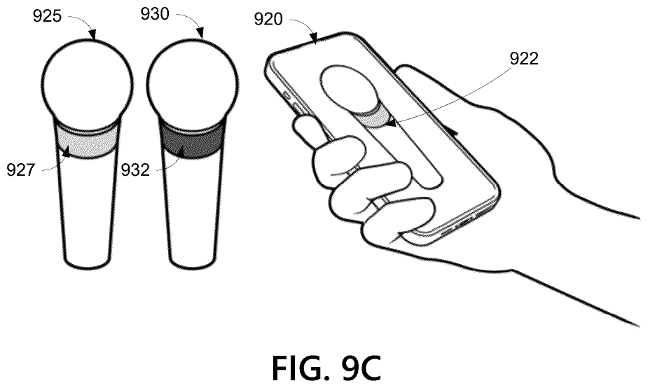

FIG. 9A, FIG. 9B, and FIG. 9C show example operation of an audio system. Specifically, FIGS. 9A-9C show user device control of microphones. As shown in FIG. 9A, an audio device 905 (e.g., a microphone) may be controlled by multiple user devices 910, 915 (e.g., smartphones/computing devices), each with its own corresponding instance of an audio system control application (e.g., a standalone application, application accessed via a web browser, etc.). The application may be used for multiple purposes. For example, the application may be used to mute or unmute the microphone, adjust a volume of the microphone, perform audio processing (e.g., noise suppression, equalization processing, etc.). Both user devices 910, 915 may use the application to control a same audio device.

The application may display, via the user devices 910, 915, a current status of the audio device 905 (e.g., whether the audio device 905 is muted, a current volume of the audio device, equalization/noise cancelation settings, etc.). One of the two user devices 910, 915 may be an administrative device associated with the audio device 905. The administrative device may invite other user devices as control devices associated with the audio device 905. For example, if user device 910 is an administrative device, the user device 910 may send a notification to the user device 915 with an indication of the audio device 905 (e.g., unique identifier of the audio device 905). Based on the indication, the user device 915 may also control the audio device 905.

An administrative device may also remove existing permissions of other user devices for controlling an audio device 905. For example, the user device 910 may send a second notification to the user device 915 and/or the audio device 905. Based on receiving the second notification, the user device 915 may drop an existing connection and/or ignore any signaling from the audio device 905. Similarly, the audio device 905 may drop an existing connection and/or ignore any signaling from the user device 915.

The audio system control application may also be used for other purposes (e.g., identifying an audio device). FIG. 9C shows example of identification of an audio device via the application. For example, a graphical user interface (GUI), displayed on a user device 910, may use a color coding scheme to identify linked audio devices. For example, audio devices 925, 930 may be linked/connected to the user device 920. Each of the audio devices 925, 930 may comprise integrated light indicators (e.g., light rings 927, 932). The user device 920 may identify the audio device 925, for example, based on a color of its light ring 927 matching a color of a light ring 922 of an audio device as illustrated in the GUI. A user associated with the user device 920 may access controls associated with the audio device 925, for example, by clicking/selecting an appropriate icon associated with the audio device as illustrated in the GUI.

The various features associated with controlling an audio device (e.g., muting a microphone, volume control, etc.) may be performed by a wireless hub. For example, based on receiving a notification to mute microphone, the wireless hub may send an indication to the microphone. Based on the received indication, the microphone may stop sending audio signals to the wireless hub. In an example, the wireless hub may selectively (and/or autonomously) mute one or more microphones based on detecting microphone feedback via the microphones.

A wireless hub may selectively mute audio from an input device (e.g., a microphone) at specific output devices (e.g., speakers). In this scenario, the muting function may be performed at the wireless hub and the wireless hub may still receive audio input from the input device. For example, a wireless hub may receive from a user device (based on user input via a GUI associated with a user device), indication of one or more output devices that are not to receive/output any received audio from a selected input device. Based on the indication, the wireless hub may not send audio signals as received from the selected input device to the one or more output devices. Other devices, however, may continue to receive audio as received from the selected input device. In an example scenario, this feature may be used to cut-off audio to remote, livestreaming audiences, but continue audio output via local output devices, or vice versa.

In at least some audio systems, a user may have to configure (e.g., via wired connections) connections between different components of the audio system. Modifying the routing between input and output devices of the system may involve manually disconnecting and reconnecting the various audio devices, which may require significant manual effort and understanding of the system layout. This may be time consuming if the user is not aware of how an audio system is wired at a location. Additional considerations may be involved in relation to compatibility between the different devices comprising the audio system. Even if a physical location is already equipped with audio devices, a user may need to bring additional devices to ensure compatibility with their existing audio output equipment and/or to provide more audio processing options.

Example functionalities (e.g., enabled by devices, systems, and applications), as described herein, may provide numerous advantages including, but not limited to, simplified setup and intuitive user control, added flexibility to support multiple applications via a same set of devices, and one-stop audio processing (e.g., via a single wireless hub controllable by a remote user interface). An example scenario may involve an audio system comprising one or more input devices (e.g., microphones), one or more output devices (e.g., headphones, speakers, streaming devices), a wireless hub, and/or one or more user devices. To use the audio system, a user may access a user device (e.g. by authenticating user credentials, as described with respect to FIG. 6). Following user authentication, the user device may present an interface (e.g., as described with respect to FIGS. 7A-7C and 8A-8C) with controls of each of the linked devices in the audio system, controls associated with post-processing the received audio, controls associated with a use case of the audio system, etc.

Controls associated with an audio device may include controls for gain/volume adjustment, directionality settings (e.g., for audio devices with spatially adjustable input/output audio patterns), muting/unmuting the audio device, etc. Controls associated with post-processing the audio may include controls for equalization, noise suppression, delay adjustment, etc. Controls associated with a use case of the audio system may comprise selections associated with how the audio output is to be used (e.g., if the audio is to be output in real-time via speakers, broadcast to a remote audience, and/or stored to memory locally and/or remotely), audio system architecture (e.g., a quantity of inputs/microphones and/or a quantity of outputs/speakers, mapping between the inputs and the outputs, etc.), etc. Based on the user selections via the interface, the user device may process the audio and/or send appropriate settings to the wireless hub to implement for audio processing. In this manner, setup and control of devices in the audio system is simplified.

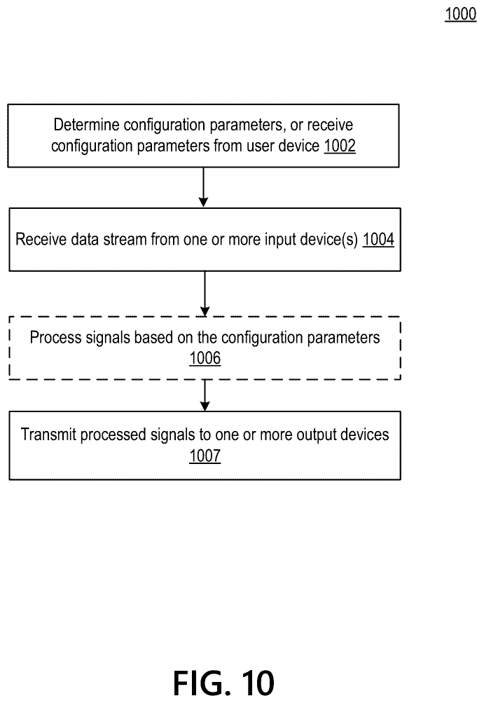

FIG. 10 shows an example method 1000 of signal processing associated with an audio system. At step 1002, the wireless hub may determine or receive, from a linked user device (e.g., a smartphone, laptop computer, tablet computer, and/or any other device), one or more configuration parameters. The configuration parameters may comprise settings associated with each of audio device associated with the audio system (e.g., microphones, speakers, musical instrument outputs, etc.). The settings may comprise volumes associated with each of the audio devices, an indication of a whether a device is muted, equalization settings, noise suppression/cancelation settings, directionality settings (e.g., if microphones/speakers with adjustable directionality are being used, etc.). At step 1004, the wireless hub may receive, from one or more input devices (e.g., capture devices or user computing devices) of the audio system, a data stream that may comprise audio signals, video signals, data, or other metadata as described herein. At step 1006, the wireless hub may optionally process one or more signals of the data stream based on the configuration parameters. It will be appreciated that processing the signals of the data stream may be performed fully partially by the wireless hub, partially by the capture devices, partially by the user computing device, or some combination of the devices. At step 1007, the wireless hub may transmit send the processed signals to one or more output devices (e.g., speakers). In one or more examples, the wireless hub may transmit the processed signals to one or more user computing devices for storage, streaming via a communication channel, or other application-specific consumption purposes.

The example methods, devices, and systems as described herein provides numerous advantages relating to simplified user operation, centralized and wireless control of multiple audio devices, and user authentication. Input devices (e.g., microphones) and output devices (e.g., wireless speakers, headphones) may automatically connect (e.g., via beacons, handshake protocols) to a wireless hub. The wireless hub may be an integrated microphone receiver, audio mixer and audio transmitter (e.g., to wireless output devices). Wireless devices and protocols may eliminate the need for physical audio connection of cables between the various devices.

The use of wireless devices and associated communication protocols enables automated discovery of devices in a wireless audio system. The wireless audio system may be modified (e.g., expanded) by integration of additional audio devices, as needed. For example, local reinforcement speakers may be flexibly integrated into the audio system to account for larger audience.

The audio system (e.g., via the wireless hub) may send received audio (e.g., from input devices), in real time, to linked user device(s) (e.g., tablets, smartphones, laptops) for processing. Further, the user device(s) may be used to control operation of the various devices of the audio system.

A user device may provide applications and GUIs for various purposes. For example, the user device may provide interfaces displaying sources of audio in the system (e.g., microphones) and output devices associated with the system. An application installed on the user device may enable control of the various devices in the audio system. The application may be used to automatically account for improper volume, placement, and/or setup of an audio source. For example, the application may provide an automixer that may be used to correct volumes of one or more devices in the audio system. The application may also be used to set up the audio system in accordance with a usage of the audio system (e.g., as a tour guide system, one-to-many system, Q/A system for an audience, an intercom system, etc.). The user device and associated application may also provide an ability to use the audio system for live streaming and recording to remote audiences without the need to connect to additional, redundant, or separate audio systems for internet connectivity.

The wireless hub may also be linked to monitoring devices (e.g., headphones). In an example application, the audio system may provide an ability to mix, process and send audio in real time to the monitoring device. A performer can produce musical content using a microphone and monitor input via a separate monitoring device. The audio system architecture may enable near real time monitoring with reduced latency/delay. The performer may use the monitoring device for personal monitoring of output audio.

The wireless hub, user devices, and associated application may enable use of digital signal processing (DSP), artificial intelligence (AI)/machine learning (ML) signal processing, and/or other signal processing. For example, an application associated with a user device and/or a wireless hub may enable/perform one or more of the above functions. The application and/or the wireless hub (e.g., using DSP, AI techniques) may identify and detect differences between desired and undesired sources of sounds. The application and/or the wireless hub may automatically correct (or prompt the user to correct) to the undesired sound sources (e.g., by muting specific microphones of the audio system, changing lobe directions of directional microphones). Audio correction may include equalization (EQ) processing for the desired source, noise reduction of undesired source (e.g., through AI-based learning), manipulation of the transducer pickup (e.g., adjusting a polar pattern of a microphone) to account for misuse or poor placement of the microphone, or AI/ML-powered direct manipulation of individual audio streams or bussing of audio streams, either through complex masking, filtering, or generative means.

For example, an AI-based learning mechanism may be used to enable a user device to distinguish between desired sounds and an undesired noise. The input from a plurality of microphones may be used to identify a source direction of the undesired noise and/or a source direction of desired sounds. A polar pattern of a microphone may be adjusted such a null point of the polar pattern is directed towards an undesired source of sound or a node of the polar pattern may be directed towards a desired direction. Additionally, or alternatively, the application and/or the wireless hub may determine and mute the microphones that are picking up noise with the highest magnitudes.

It will be appreciated that examples herein may employ both DSP techniques as well as AI/ML techniques for signal processing or other detections or functions described herein. In such examples, AI/ML may be used to address the problem of removing the undesired source directly or removing the source after additionally performing, via DSP, for example, physical means of increasing the desired to undesired ratios first.

The application may display/indicate (e.g., via the GUI) microphones that are picking up the highest noise. A user, via the GUI and/or a voice command, may mute the microphones that are picking up the most noise.

DSP, as performed in the audio system (e.g., by the wireless hub, one or more user devices), may comprise digital feedback reduction (DFR). A wireless hub, for example, using DFR may analyze received audio and detect frequencies and/or frequency ranges at which a feedback is detected by the wireless hub. Based on detecting the feedback, the wireless hub may (e.g., autonomously) apply filters (e.g., a low-pass filter, a high pass filer, a bandpass filter(s), etc.) to remove/suppress audio at frequencies in which feedback is detected. The wireless hub may monitor (e.g., periodically monitor) input audio to determine presence of feedback. The applied filters may be removed, for example, if the wireless hub can no longer detect feedback at those frequencies/frequency ranges and/or if a time duration has expired. It will be appreciated that functionality described herein may also, or alternatively, be implemented using AI/MI techniques.

Hereinafter, various characteristics will be highlighted in a set of numbered clauses or paragraphs. These characteristics are not to be interpreted as being limiting on the invention or inventive concept but are provided merely as a highlighting of some characteristics as described herein, without suggesting a particular order of importance or relevancy of such characteristics.

Clause 1. A wireless hub comprising one or more processors and memory storing instructions that, when executed by the one or more processors, cause the wireless hub to: wirelessly receive, from at least one of a plurality of input devices, one or more audio signals; generate one or more processed audio signals by applying processing to the one or more audio signals; and wirelessly transmit the one or more processed audio signals to one or more user computing devices or one or more output devices, wherein the wireless hub is configured to wirelessly receive signals via a plurality of wireless input connections having different communication protocols, and to wirelessly transmit signals via a plurality of wireless output connections having different communication protocols.

Clause 2. The wireless hub according to clause 1, wherein applying processing to the one or more audio signals comprises performing one or more of gain adjustment, equalization processing, noise suppression, signal detection, environmental detection, localization, separation, de-reverberation, use case detection, audio enhancement, automatic stem generation, AI/ML signal processing, digital signal processing, identification, instrument detection, denoising, speech enhancement, instrument enhancement, dynamic processing, compression, gating, routing determination, level determination, level adjusting, mixing, or auto-mixing.

Clause 3. The wireless hub according to any of the foregoing clauses, wherein the wireless hub is further configured to wirelessly receive a data stream from the plurality of input devices.

Clause 4. The wireless hub according to any of the foregoing clauses, wherein the data stream comprises one or more of audio signals, video signals, metadata, positional data, orientation data, data associated with NFC devices, or clock synchronization data.

Clause 5. The wireless hub according to any of the foregoing clauses, wherein the data stream comprises processed audio signals processed by one or more of the plurality of input devices.

Clause 6. The wireless hub according to any of the foregoing clauses, wherein mixing or auto-mixing comprises combining the one or more processed audio signals with pre-processed or mixed audio signals received from the one or more input devices.

Clause 7. The wireless hub according to any of the foregoing clauses, wherein mixing or auto-mixing is applied based on instructions received from the one or more user computing devices.

Clause 8. The wireless hub according to any of the foregoing clauses, wherein a duration between a departure of the one or more audio signals from the at least one of the plurality of input devices and an arrival of the processed signals at the one or more output devices is less than one of 5 ms, 10 ms, 15 ms, or 20 ms.

Clause 9. The wireless hub according to any of the foregoing clauses, wherein the plurality of wireless input connections comprises three (3) or more wireless input connections.

Clause 10. The wireless hub according to any of the foregoing clauses, further configured to wirelessly receive, from at least one of the plurality of input devices or the one or more output devices, a request to establish a connection; and based on receiving the request, send an indication of acceptance of the connection to the at least one of the plurality of input devices.

Clause 11. The wireless hub according to any of the foregoing clauses, wherein the different communication protocols comprise Bluetooth protocol, an Institution of Electrical and Electronics Engineers (IEEE) 802.11 WIFI protocol, a 3rd Generation Partnership Project (3GPP) cellular protocol, a local area network (LAN) protocol, a hypertext transfer protocol (HTTP), industrial, scientific, and medical (ISM) bands, a very high frequency (VHF) band, an ultra high frequency (UHF) band, DECT, or RF bands.

Clause 12. The wireless hub according to any of the foregoing clauses, wherein applying the processing comprises at least determining a correct routing and a level for received audio signals based on one or more of their respective input device, an input source, or an intended destination output device.

Clause 13. The wireless hub according to any of the foregoing clauses, wherein the instructions, when executed by the one or more processors, cause the wireless hub to: determine or receive, from at least one of the one or more user devices, one or more configuration parameters, wherein applying the processing is based on the one or more configuration parameters.

Clause 14. The wireless hub according to any of the foregoing clauses, wherein the instructions, when executed by the one or more processors, cause the wireless hub to: determine or receive, from at least one of the one or more user devices, a mapping between the plurality of input devices and the one or more output devices.

Clause 15. The wireless hub according to any of the foregoing clauses, wherein the plurality of input devices comprises one or more of a wireless video capture device, a wireless audio capture device, a computing device, a wireless microphone, a wearable pack associated with a microphone, a wireless headset integrated with a microphone, or a transceiver associated with a musical instrument.

Clause 16. The wireless hub according to any of the foregoing clauses, wherein the one or more output devices comprise one or more of a computing device, an audio output device, a speaker, a wearable pack associated with a microphone, a wireless headset, a user computing device, an XLR output connector, a dongle, or a transceiver associated with a musical instrument.

Clause 17. The wireless hub according to any of the foregoing clauses, wherein the wireless hub is configured to be wirelessly powered.

Clause 18. An audio system, comprising one or more wireless hubs, a plurality of input devices, one or more output devices, and one or more user computing devices, wherein the one or more wireless hubs comprise one or more processors and memory storing instructions that, when executed by the one or more processors, cause a wireless hub of the one or more wireless hubs to: wirelessly receive, from at least one of the plurality of input devices, one or more audio signals; generate one or more processed audio signals by applying processing to the one or more audio signals; and wirelessly transmit the one or more processed audio signals to the one or more user computing devices and the one or more output devices, wherein the wireless hub is configured to wirelessly receive signals via a plurality of wireless input connections having different communication protocols, and to wirelessly transmit signals via a plurality of wireless output connections having different communication protocols.

Clause 19, an audio system according to clause 18, wherein a duration between a departure of the one or more audio signals from the at least one of the plurality of input devices and an arrival of the processed audio signals at the one or more output devices is less than one of 5 ms, 10 ms, 15 ms, or 20 ms.

Clause 20, an audio system according to any of the foregoing clauses, wherein the one or more output devices are configured to: receive the one or more processed audio signals; and receive one or more additional audio signals from one or more of the plurality of input devices.

Clause 21: A microphone comprising one or more processors; and memory storing instructions that, when executed by the one or more processors, cause the microphone to indicate, via an integrated indicator, a current status of the wireless microphone.

Clause 22. The microphone of clause 21, wherein the integrated indicator comprises at least one of a: a light ring indicator, a vibration motor, a speaker.

Clause 23. The microphone of any of the foregoing clauses, further comprising a light ring indicator configured to progressively light up based on a battery fill status.

Clause 24. The microphone of any of the foregoing clauses, wherein the instructions, when executed, cause the microphone to connect to a user device based on receiving a request to connect to the user device.

Clause 25. The microphone of any of the foregoing clauses, wherein the instructions, when executed, cause the microphone to connect to a user device based on receiving a request, from a second user device, to connect to the user device and/or cause the microphone to disconnect from a user device based on receiving a request, from a second user device, to disconnect to the second user device.

Clause 26. The microphone of any of the foregoing clauses, wherein the microphone is configured to process at least a portion of audio signals received via the microphone prior to transmitting the audio signals to a wireless hub or a user computing device.

Clause 27. The microphone of any of the foregoing clauses, wherein the instructions, when executed, cause the microphone to display, via a light ring indicator and based on a request from a user device, a light of a specific color, wherein the request comprises an indication of the light color.

Clause 28. A user device comprising one or more processors; and memory storing instructions that, when executed by the one or more processors, cause the user device to send a request to connect an audio device, in an audio system, to the user device.

Clause 29. The user device of clause 28, wherein the instructions, when executed, cause the user device to send a request to connect a second user device to a microphone.

Clause 30. The user device of any of the foregoing clauses, wherein the instructions, when executed, cause the user device to send a request to disconnect a second user device from a microphone.

Clause 31. A method comprising receiving, from a server, an indication of one or more audio devices associated with a user account, and causing sending a request to connect to at least one of the one or more audio devices.

Clause 32. The method of clause 31, further comprising, causing presenting via a display screen, provide a graphical user interface (GUI) comprising separate controls for each of the one or more audio devices.

Clause 33. A method at a wireless hub, associated with an audio network, comprising detecting an audio system device.

Clause 34. The method of clause 33, further comprising establishing a connection with the audio system device.

Clause 35. The method of any of the foregoing clauses, further comprising receiving, from one or more audio input devices, associated with the audio network, input audio.

Clause 36. The method of any of the foregoing clauses, further comprising, processing the input audio.

Clause 37. The method of any of the foregoing clauses, further comprising sending the output audio to one or more output devices.

Clause 38. The method of any of the foregoing clauses, further comprising detecting a second audio system device, establishing a connection with the second audio system device.

Clause 39. The method of any of the foregoing clauses, wherein the one or more audio input devices comprises the audio system device.

Clause 40. The method of any of the foregoing clauses, wherein the one or more audio output devices comprises the audio system device.

Clause 41. The method of any of the foregoing clauses, wherein the audio system device comprises an audio input device, an audio output device, or another wireless hub.

Clause 42. The method of any of the foregoing clauses, wherein the establishing the connection is based on a beacon protocol.

Clause 43. The method of any of the foregoing clauses, wherein the processing the input audio comprises performing one or more of gain adjustment, volume control, equalization, mixing, auto-mixing, or noise suppression.

Clause 44. A wireless hub comprising one or more processors and memory storing instructions that, when executed by the one or more processors, cause the wireless hub to perform the method of any of the foregoing clauses.

Clause 45. A system comprising: a wireless hub configured to perform the method of any of the foregoing clauses, and a user device configured to send configuration parameters associated with processing the input audio.

Clause 46. A computer-readable medium storing instructions that, when executed, cause performance of the method any of the foregoing clauses.

Clause 47. An audio system according to any of clauses 18-20, wherein the one or more wireless hubs comprise a wireless hub according to any of clauses 1-17.

Clause 48. A wireless hub according to clause 1, wherein the wireless hub is configured to generate and transmit control signals to one or more of the plurality of input devices, the one or more user computing devices, or the one or more output devices.

Clause 49. A wireless hub according to clause 1, wherein the plurality of wireless output connections comprises three (3) or more wireless output connections.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

1. A wireless hub comprising one or more processors and memory storing instructions that, when executed by the one or more processors, cause the wireless hub to:
wirelessly receive, from at least one of a plurality of input devices, one or more audio signals;
generate one or more processed audio signals by applying processing to the one or more audio signals; and
wirelessly transmit the one or more processed audio signals to one or more user computing devices or one or more output devices, wherein the wireless hub is configured to wirelessly receive signals via a plurality of wireless input connections having different communication protocols, and to wirelessly transmit signals via a plurality of wireless output connections having different communication protocols.

2. The wireless hub of claim 1, wherein applying processing to the one or more audio signals comprises performing one or more of gain adjustment, equalization processing, noise suppression, signal detection, environmental detection, localization, separation, de-reverberation, use case detection, audio enhancement, automatic stem generation, AI/ML signal processing, digital signal processing, identification, instrument detection, denoising, speech enhancement, instrument enhancement, dynamic processing, compression, gating, routing determination, level determination, level adjusting, mixing, or auto-mixing.

3. The wireless hub of claim 1, wherein the wireless hub is further configured to wirelessly receive a data stream from at least one of the plurality of input devices.

4. The wireless hub of claim 3, wherein the data stream comprises one or more of audio signals, video signals, metadata, positional data, orientation data, data associated with NFC devices, or clock synchronization data.

5. The wireless hub of claim 3, wherein the data stream comprises processed audio signals processed by the at least one input device of the plurality of input devices.

6. The wireless hub of claim 2, wherein mixing or auto-mixing comprises combining the one or more processed audio signals with pre-processed or mixed audio signals received from the at least one input device.

7. The wireless hub of claim 3, wherein mixing or auto-mixing is applied based on instructions received from the one or more user computing devices.

8. The wireless hub of claim 1, wherein a duration between a departure of the one or more audio signals from the at least one of the plurality of input devices and an arrival of the processed signals at the one or more output devices is less than one of 5 ms, 10 ms, 15 ms, or 20 ms.

9. The wireless hub of claim 1, wherein the plurality of wireless input connections comprises three (3) or more wireless input connections.

10. The wireless hub of claim 1, wherein the plurality of wireless output connections comprises three (3) or more wireless output connections.

11. The wireless hub of claim 1, wherein the instructions, when executed by the one or more processors, cause the wireless hub to:
wirelessly receive, from at least one of the plurality of input devices or the one or more output devices, a request to establish a connection; and
based on receiving the request, send an indication of acceptance of the connection to the at least one of the plurality of input devices.

12. The wireless hub of claim 1, wherein the different communication protocols comprise Bluetooth protocol, an Institution of Electrical and Electronics Engineers (IEEE) 802.11 WIFI protocol, a 3rd Generation Partnership Project (3GPP) cellular protocol, a local area network (LAN) protocol, a hypertext transfer protocol (HTTP), industrial, scientific, and medical (ISM) bands, a very high frequency (VHF) band, an ultra high frequency (UHF) band, DECT, or RF bands.

13. The wireless hub of claim 1, wherein applying the processing comprises at least determining a correct routing and a level for received audio signals based on one or more of their respective input device, an input source, or an intended destination output device.

14. The wireless hub of claim 1, wherein the instructions, when executed by the one or more processors, cause the wireless hub to:
determine or receive, from at least one of the one or more user devices, one or more configuration parameters, wherein applying the processing is based on the one or more configuration parameters.

15. The wireless hub of claim 1, wherein the instructions, when executed by the one or more processors, cause the wireless hub to:
determine or receive, from at least one of the one or more user devices, a mapping between the plurality of input devices and the one or more output devices.

16. The wireless hub of claim 1, wherein the plurality of input devices comprises one or more of a wireless video capture device, a wireless audio capture device, a computing device, a wireless microphone, a wearable pack associated with a microphone, a wireless headset integrated with a microphone, or a transceiver associated with a musical instrument.

17. The wireless hub of claim 1, wherein the one or more output devices comprise one or more of a computing device, an audio output device, a speaker, a wearable pack associated with a microphone, a wireless headset, a user computing device, an XLR output connector, a dongle, or a transceiver associated with a musical instrument.

18. The wireless hub of claim 1, wherein the wireless hub is configured to be wirelessly powered.

19. The wireless hub of claim 1, wherein the wireless hub is configured to generate and transmit control signals to one or more of the plurality of input devices, the one or more user computing devices, or the one or more output devices.

20. An audio system, comprising one or more wireless hubs, a plurality of input devices, one or more output devices, and one or more user computing devices, wherein the one or more wireless hubs comprise one or more processors and memory storing instructions that, when executed by the one or more processors, cause a wireless hub of the one or more wireless hubs to:
wirelessly receive, from at least one of the plurality of input devices, one or more audio signals;
generate one or more processed audio signals by applying processing to the one or more audio signals; and
wirelessly transmit the one or more processed audio signals to the one or more user computing devices or the one or more output devices, wherein the wireless hub is configured to wirelessly receive signals via a plurality of wireless input connections having different communication protocols, and to wirelessly transmit signals via a plurality of wireless output connections having different communication protocols.
